(19) United States
(12) Patent Application Publication
(10) Pub. No.: US 2019/0003251 A1
(43) Pub. Date: Jan. 3, 2019

(54) INTERNAL INSULATING WINDOW SHADE

(71) Applicant: WARMSOFT LLC, Portland, ME (US)

(72) Inventor: Jonathan AMORY, Portland, ME (US)

(21) Appl. No.: 16/064,390

(22) PCT Filed: May 19, 2017
(86) PCT No.: PCT/US2017/033679

§ 371 Date: Jun. 20, 2018

Related U.S. Application Data
(60) Provisional application No. 62/338,568, filed on May 19, 2016.

(30) Foreign Application Priority Data
May 18, 2017 (US) 16064390

(51) Int. Cl. E06B 9/264; E06B 9/262; E06B 9/322

(52) U.S. Cl. CPC E06B 9/264; E06B 9/262; E06B 2009/2488; E06B 2009/2646; E06B 2009/2627; E06B 9/322

(57) ABSTRACT

An insulating window shade has a compressible fill container having a first end and a second end, wherein the first end of the compressible fill container is configured to be moveable between an expanded position and a compressed position. A fill material is disposed substantially uniformly within the compressible fill container, wherein the fill material is capable of being repeatedly compressed and expanded as the compressible fill container is moved between the expanded position and the compressed position. The fill material forms a thermal boundary for trapping gas, reducing convection and contribute to aesthetic properties of the window shade. A divider control and coordination system enables movement of the divider, thereby changing the aesthetic and/or insulating properties of the insulating window panel. In the compressed position, the length of the compressible fill container is approximately 25% or less than the length of the compressible fill container in the expanded position.

### CROSS-REFERENCE TO RELATED APPLICATIONS

This application claims benefit of priority of U.S. Provisional Patent Application 62/338,568 filed May 19, 2016, which is incorporated herein by reference.

### FIELD OF THE INVENTION

The invention described herein relates generally to multi-pane insulating windows. More specifically, the present invention relates to multi-pane windows having improved aesthetics and insulating properties for use in framed window applications and systems.

### BACKGROUND OF THE INVENTION

The traditional glazed window is a significant improvement in the insulating properties of windows for preventing heat transfer between the exterior and interior of a heated or cooled space. Glazed windows typically consist of two or more panes of glass separated by a sealed interior space. The sealed interior space between the panes may be filled with an inert gas, such as argon, krypton or xenon, or left as a vacuum. Gas-filled glazed windows provide significantly lower thermal conductivity than air. The glazed window provides additional insulating properties when one or more of the panes are coated with a low-emissivity (“low-E”) glass for reduction of heat transfer through the window.

Traditional gas-filled glazed windows, however, are susceptible to internal convection leading to decreased thermal efficiency. As the gas within the sealed interior space contacts the colder pane of the glazed window, the temperature of the gas decreases, becomes denser and begins to sink. Conversely, as the interior gas contacts the warmer pane, the temperature of the gas increases, becomes less dense and rises. The sinking and rising of gas transports heat from the warmer pane to the cooler pane. This transfer of heat decreases the insulating efficiency of the glazed window.

Vacuum insulated glass (or “VIG”) glazed windows have no gases within the interior space; thus, VIG windows allow more heat transfer through radiation than gas-filled windows because the benefits of an insulating gas are not present. VIG windows have an additional set of drawbacks. A perfect vacuum must be maintained at all times, which is difficult on a large flat surface such as a window. Stresses caused by wind and differences in temperature between the inside and outside cause panes to bend and flex. Additionally, spacers installed between the panes to maintain separation and to resist the external air pressure disrupt the aesthetics and clarity of the window panel.

Regardless of the type of window, glazed or unglazed, vacuum or gas-filled, a variety of shade types may be installed exterior to the window panes to cover some portion of the window. Traditional shades disrupt some thermal and radiant heat transfer, but take up space and do nothing to prevent convection within the interior space of a gas-filled glazed window. Also known in the art are shades installed between the two window panes of a glazed window. Such internal shades provide some reduction in the transfer of radiant heat by blocking light through the window. However, prior art shades suffer a number of drawbacks and inefficiencies. Typically, such shades are controlled by pulls and robes attached through the seal of the glazed window. The holes for the ropes compromise or make impracticable the sealing required of gas-filled glazed windows. Additionally, hardware to move the shade up and down in prior art windows is prone to failure. Once sealed, glazed windows are not easily unsealed for repair of internal components. Once sealed and installed in a residential or commercial building, the removal and repair of the window panel is cost prohibitive.

Generally, it is can be desirable to have a window panel that is translucent rather than transparent. This can be done with a window shade, where the window panel is transparent in one state, and translucent or opaque in another. It can also be obtained by a window panel that is permanently in a translucent state. In single-state or multi-state applications, the quality and effect of the translucent panel can be created or changed by filling the space between panes of glass with different materials. Multiple layers of glass and filler materials may be used to create a layered effect. However, prior art shades installed internally or externally to a glazed window provide limited aesthetic options for filtering and enhancing the light passing into the space. Furthermore, many energy-efficient building designs call for translucent panels and the treatment of the glass in windows. Maximizing passive lighting and reducing heating and cooling costs by incorporating energy-efficient insulating windows requires attention to lighting aesthetics. With such constraints on energy efficiency, it is often difficult to create complex lighting aesthetics such as three-dimensional translucent textures using known window treatments and designs. Prior art windows also lack the means to contain and control the portion of the window covered or to provide reliability and long-life of the aesthetic and insulating properties.

Consequently, there is a need for improved insulating windows having improved insulating properties while providing for enhanced aesthetics of the light passing through the window into the illuminated space.

### BRIEF SUMMARY OF THE INVENTION

The benefits and advantages of the present invention over existing insulating window shades and insulating window panels will be readily apparent from the Brief Summary of the Invention and Detailed Description to follow. One skilled in the art will appreciate that the present teachings can be practiced with embodiments other than those summarized or disclosed below.

In one aspect of the invention, an insulating window shade is provided for installation within the interior space between sealed window panes. The window shade has a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position. A fill material is disposed substantially uniformly within the compressible fill container, wherein the fill material is capable of being repeatedly compressed and expanded as the compressible fill container is moved between the expanded position and the compressed position. The compressible fill container, when in the compressed position, has a length approximately 25% or less than the length of the compressible fill container in the expanded position.

In one embodiment, the fill material is transparent or translucent, and may be comprised of natural or synthetic down, wool, cotton, fiberglass, paper, or foam. In a further embodiment, the fill material is down with a fill power from approximately 300 in³/oz (175 cm³/g) to 900 in³/oz (520 cm³/g), preferably 800 in³/oz (460 cm³/g).

In another embodiment, the compressible fill container is comprised of a mesh fabric forming compartments for holding and maintaining a substantially uniform distribution of fill material. Such compartments may be formed as traditional baffles, box baffles, slant baffles, “V” baffles, vertical baffles, or trapezoidal baffles by horizontal and/or vertical stitching. The fabric of the compressible fill container may be transparent or translucent, and may be comprised of synthetic or natural cotton, nylon mesh (e.g. wedding veil-like), or polylatic (e.g. tea bag-like) material.

In some embodiments, the insulating window shade may further comprising a divider member attached to a second end of the compressible fill container, the divider member having one or more magnets, which when magnetically engaged with an external divider control enables movement of the second end of the compressible fill container relative to the first end of the compressible fill container, thereby changing the aesthetic and/or insulating properties of the insulating window shade.

In a second aspect of the invention, there is provided an insulating window panel for installation in a window frame, the window panel comprising a first window pane having a first outer edge and a second window pane having a second outer edge, wherein the first outer edge of the first window pane and the second outer edge of the second window pane are aligned and in a spaced relationship to one another, and wherein the first window pane and the second window pane are joined along their respective outer edges to form a sealed interior space. An internal insulating window shade according to the above first aspect of the invention and its embodiments is disposed within the interior space formed between the first and second window panes, the interior insulating window shade comprising a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position. A fill material is disposed substantially uniformly within the compressible fill container, wherein the fill material is capable of being repeatedly compressed and expanded as the compressible fill container is moved between the expanded position and the compressed position. The compressible fill container, when in the compressed position, has a length approximately 25% or less than the length of the compressible fill container in the expanded position. In a preferred embodiment, the interior space of the insulating window panel between the first and second window pane is substantially uniformly filled with a gas selected from air, argon or krypton. Filling the space between two window panes with down and argon gas, for example, produces an insulating panel that also creates a “cozy” and translucent aesthetic. The first and second window pane may also include a low-E coating on a surface of the first or second window pane.

In some embodiments, the insulating window shade may further comprise a divider member attached to a second end of the compressible fill container, the divider member having one or more magnets, which when magnetically engaged with an external divider control enables movement of the second end of the compressible fill container relative to the first end of the compressible fill container, thereby changing the aesthetic and/or insulating properties of the insulating window shade. The divider member may comprise one or more magnets integrally formed at a first end and at a second end of the divider member. The one or more magnets at the first and second ends of the divider member may be disposed to face an interior surface of the first and second window panes. Alternatively, or additionally, the one or more magnets at the first and second ends of the divider member may be disposed to face an interior edge of the interior space formed by the joining of the first or second window panes.

In a further embodiment, the insulating window shade moves freely within the interior space of the window panes. In other embodiments, the window panel further comprises divider guide assembly disposed on at least one end of the divider member for engaging corresponding guide assembly disposed along an interior edge of the interior space formed by the joining of the first or second window pane. Divider guide assembly may comprise a “T” track or inverted “T” track disposed on each end of the divider member, and an inverted “T” track or “T” track disposed along a corresponding interior edge of the interior space of the window panel. Alternatively, divider guide assembly may comprise roller bearing means disposed on each end of the divider member in communication with roller bearing track means disposed along a corresponding interior edge of the interior space of the window panel. In yet another embodiment, the divider guide assembly may comprise arrangements of ball bearings and tracks. The insulating window panel may further comprise a low friction device or material interposed between the divider member and an interior surface of the first or second window pane allowing the divider member to move freely within the interior space of the window panel.

In some embodiments, the insulating window shade may be disposed vertically or horizontally within the interior space of the window panel formed by rectangular first and second window panes. In a non-rectangular window embodiment, the insulating window shade may be disposed within the interior space of the window panel formed by substantially round first and second window panes.

In a third aspect of the invention, a window assembly is provided for installation in a window frame. The window assembly comprises an external divider control having one or more divider engagement members, the divider engagement members having one or more magnets integrally formed thereto and disposed external to the insulating window panel. The window assembly includes an insulating window panel according to the above second aspect of the invention and its embodiments, including a first window pane having a first outer edge and a second window pane having a second outer edge, wherein the first outer edge of the first window pane and the second outer edge of the second window pane are aligned and in a spaced relationship to one another, and wherein the first window pane and the second window pane are joined along their respective outer edges to form a sealed interior space. An insulating window shade according to the first aspect of the invention above and its embodiments is disposed within the interior space formed between the first and second window panes. The interior insulating window shade includes a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position. The fill material is disposed substantially uniformly within the compressible fill container, wherein the fill material is capable of being repeatedly compressed and expanded as the compressible fill container is moved between the expanded position and the compressed position, wherein, when in the compressed position, the length of the compressible fill container is approximately 25% or less than the length of the compressible fill container in the expanded position. The window assembly may further include a divider member attached to the second end of the compressible fill container, the divider member comprising one or more magnets, which when magnetically engaged with an external divider control enables movement of the second end of the compressible fill container relative to the first end of the compressible fill container, wherein the external divider control provides for translation of the one or more divider engagement members enabling movement of the divider member, thereby compressing the compressible file container and changing the aesthetic and/or insulating properties of the insulating window panel.

In a preferred embodiment, the external divider control of the insulating window assembly includes two divider engagement members, each having one or more magnets integrally formed and which magnetically couple to magnets integrally formed on a corresponding first and second end of the divider member. The external divider control assembly may comprise a lead screw assembly for coordinated movement of the divider engagement members. Alternatively, the external divider control may comprise a conveyor belt assembly for coordinated movement of the divider engagement members. The conveyor belt assembly or lead screw assembly may be manually actuated or may be motorized under control by an external control programmable controller. Alternatively, the external divider control may comprise a single divider engagement member having one or more magnets integrally formed and which magnetically couple to magnets integrally formed on a corresponding first and second end of the divider member, the single divider engagement member being manually or automatically controlled.

### BRIEF DESCRIPTION OF THE FIGURES

Embodiments of the present invention will now be described, by way of example only, with reference to the attached Figures, wherein:

FIG. 1 shows a prior art conventional window frame having glazed window panes and an exterior conventional window shade.

FIG. 2 shows a prior art window panel having glazed window panes and an internal window shade with pulley and rope controls.

FIGS. 3A-3C show aspect of the insulating window shade, an insulating window panel, and an insulating window assembly housed in a conventional window frame.

FIGS. 4A-4C depict an embodiment of an insulating window shade having a compressible fill container having a quilted structure with details of one embodiment having substantially uniform distribution of fill material.

FIGS. 4D and 4E depict properties of fill material for use in a compressible fill container of the present invention.

FIGS. 5A-5D show alternative compressible fill container structures illustrating compressibility of the compressible fill container for a preferred embodiment of the insulating window shade.

FIGS. 6A-6C shows an embodiment of the insulating window shade installed in a glazed window panel.

FIGS. 7A and 7B-7D depict a perspective view of the insulating window shade of the present invention and alternative embodiments of magnet disposed in a divider of the window shade.

FIGS. 8A-8E show divider end views of an insulating window shade installed in an insulating window panel with alternative embodiments of divider guide assemblies.

FIG. 9 provides an overview of the insulating window assembly of the present invention for discussion of the divider control, divider engagement, and divider engagement coordination as further depicted in FIGS. 10A-12B.

FIGS. 10A and 10B illustrate two embodiments of divider control for moving a divider of an insulating window shade within an insulating window panel.

FIGS. 11A and 11B show two embodiments of divider engagement at one end of the divider of an insulating window shade within an insulating window panel.

FIGS. 12A and 12B show two embodiments of divider engagement coordination for an insulating window assembly.

FIGS. 13A-13C show alternative embodiments of the insulating window shade and insulating window panel installed in convention window frames have different geometries.

### DETAILED DESCRIPTION OF THE INVENTION

Described herein is a highly efficient, insulating window shade and panel structure for installation within a low-conductivity window frame.

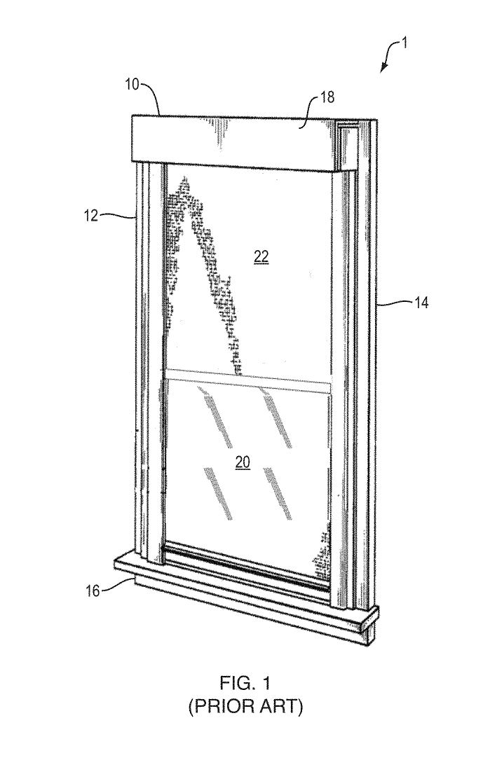

FIG. 1 shows a prior art window frame 1 having glazed window panes and externally mounted, conventional window shade. A conventional window frame generally has a head member 10, side members 12, 14, a sill member 16, and may include valence 18 as shown. Such windows frames may be pre-fabricated or custom-built for any particular installation. Such conventional windows may include a single-pane or double-pane glazed window panel 20 fixed to the window frame in a parallel configuration. Exterior to the window panel, a window shade 22 providing light filtering or blocking may be attached to head member 10 or valence 18 for extension downward over all or a portion of the window panel. As previously mentioned, traditional shades provide some reduction in heat transfer but do nothing to prevent convection within a sealed, gas-filled window panel.

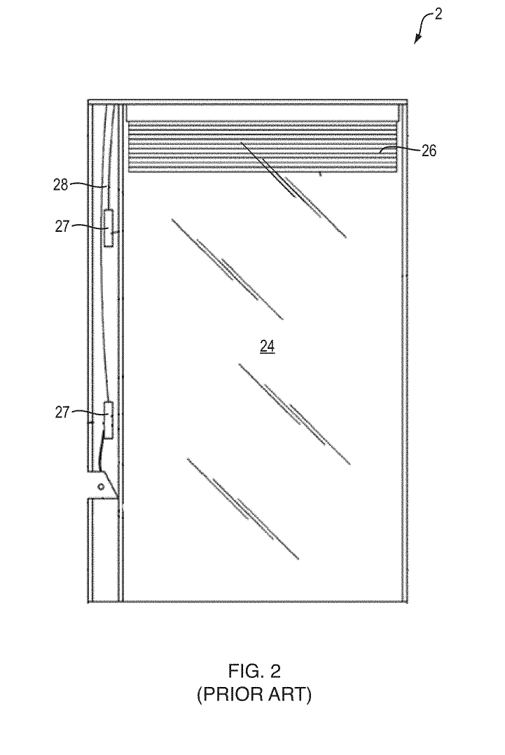

FIG. 2 shows a prior art window panel 2 having double-pane glazed window panel 24 having an internal window shade 26 installed between the panes of the glazed window. As shown, internal shade 26 is controlled by pulls 27 and ropes 27 to move the shade up and down within the window panel. The pull being exterior to the panel requires the passing of the ropes into the interior space of window panel. As above, such an internal shade arrangement is not suitable for gas-filled glazed window and introduces unreliable hardware between the seal window panes.

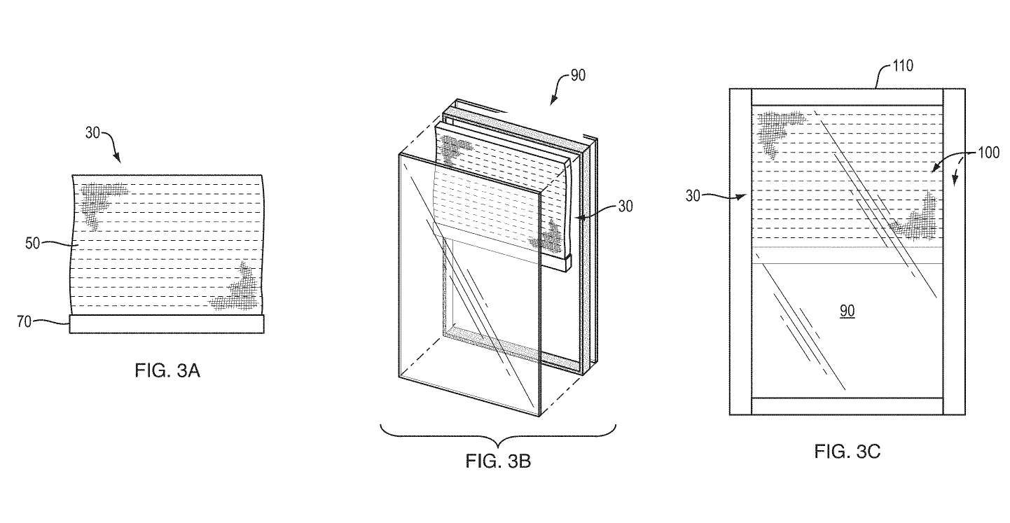

FIG. 3A depicts insulating window shade 30 according to one aspect of the invention. In FIG. 3A is shown insulating window shade 30 is comprised of compressible fill container 50 and may include divider 70 attached at one end thereto. Fill container 50 may include fill material 80 disposed within compartments formed therein. FIG. 3B depicts insulating window panel 90 according to a second aspect of the invention. In FIG. 3B is shown insulating window shade 30 fixed at one end of fill container 50 including divider moveably disposed within the interior space of window panel 90. Window shade 30 may be placed between the panes such that the insulating window shade is entirely above or below or to one side of the divider. FIG. 3C depicts insulating window assembly 100 installed in window frame 110, the frame hiding or partially hiding window panel 90 according to a third aspect of the invention. Divider controls (not shown or hidden in frame) of the insulating window assembly 100 enable the movement of divider 70 to compress and expand fill container 50 within window panel 90. Details of these and further aspects of the invention and their operation follow.

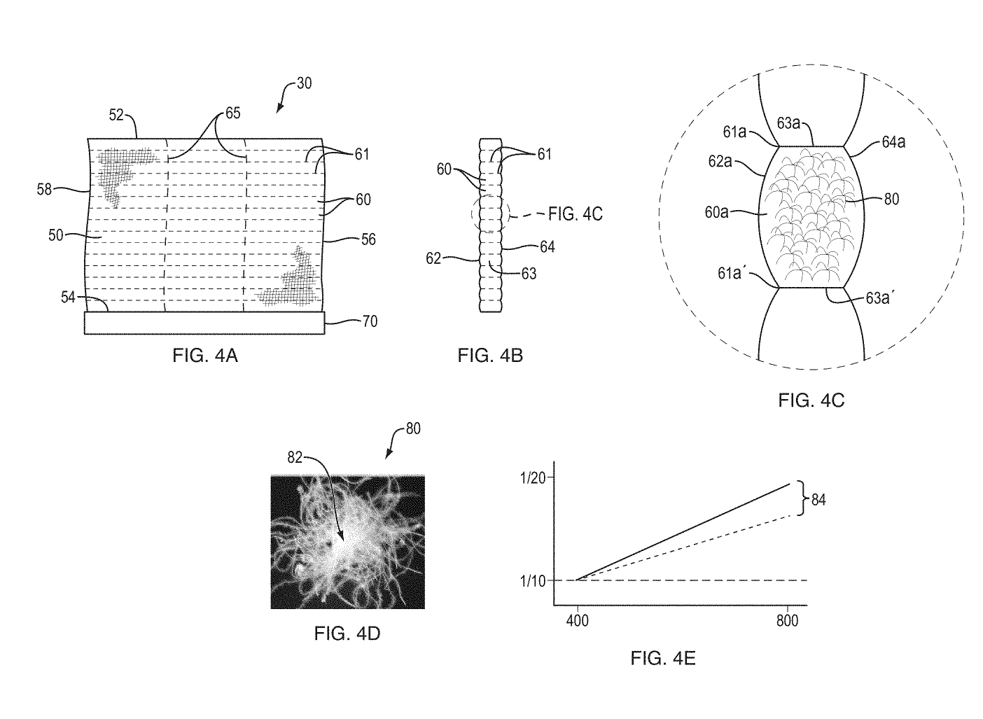

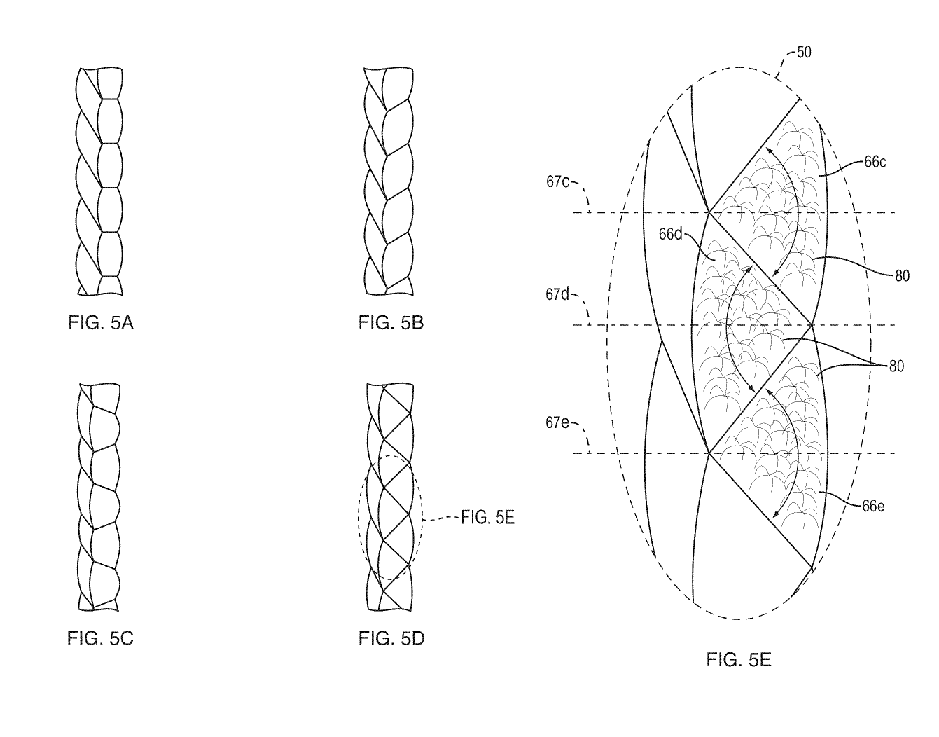

As shown in FIG. 4A, insulating window shade 30 is comprised of compressible fill container 50 having a top end 52, bottom end 54 and side edges 56, 58. Attached to fill container 50 along bottom end 54 may be divider 70, which may be comprised of a rigid material. Fill container 50 may be constructed of one or more pieces of a material allowing for compression and expansion of the fill container. As divider 70 attached to bottom end 54 moves from a first position to a second position with reference to a fixed position of the top end 52 of fill container 50, window shade 30 may expand (inflate) or compress (deflate) to cover more or less of window panel 90. When disposed in window panel 90 the insulating window shade is thus capable of changing the aesthetic and/or insulating properties of light passing and heat transfer through the window.

As illustrated in fill container end view FIG. 4B, fill container 50 may be constructed to form compartments 60 by horizontal stitching 61 together of fabric pieces 62, 63, 64 into a quilt structure according to methods known in the art. Fabric pieces 62, 63, 64 may be transparent or translucent to allow for filtering and/or enhancement of light passing through fill container 50. Preferably, fill container is constructed from a gas-permeable or mesh fabric of natural or synthetic manufacture, such as cotton or nylon mesh (e.g. wedding veil-like) or polylatic (e.g. tea bag-like) material. Fill container 50 may further include vertical stitching 65 in some embodiments to secure fill material 80 from horizontal migration along compartments 60.

As further illustrated in FIG. 4C for one of compartments 60, a compressible fill material 80 is disposed substantially uniformly within cell 60a formed by fabric pieces 62a, 63a, 64a, and 63a′ with stitching 61a and 61a′ forming the cell structure. For illustration, only fill material of cell 60a is shown here. Fabric pieces forming the cell walls of cell 60a hold fill material 80 in place during compression and expansion of fill container 50. Preferably, fill material 80 has low thermal conductivity, is highly compressible, aesthetically enhances light passing through it, and has a long life span during repeated compression and expansion of fill container 50. Fill material 80 is comprised of a material capable of trapping gas and thus forming a thermal boundary layer within the fill container, such as natural or synthetic down, wool, cotton, fiberglass, paper, or foam.

As shown in FIG. 4D, fill material 80 may be natural or synthetic down. Down used as fill material may have a fill power of from approximately 300 cubic inches per oz, in³/oz, (175 cm³/g) to 900 in³/oz (520 cm³/g). One skilled in the art would understand that the higher the fill power the larger the down cluster 82. The larger the cluster the more gas that can be trapped by the down. The more gas trapped per volume of down increases the insulating properties per weight of fill material. A higher fill power (less material per space) also increases compressibility of the fill. Thus, increased compressibility of the fill container 50 allows more of the insulating window shade 30 to be compressed within window panel 70 when installed in window frame 110 as part of window assembly 100. For example, a fill material of 400 in³/oz may result in compression to approximately one-tenth ( 1/10) of the full length of the fill container. As illustrated by FIG. 4E, a fill power of 800 in³/oz may result in compression to approximately one-tenth ( 1/20) of the full length of the fill container. For the same amount of insulating efficiency, a higher fill power results in less space used at the top of a window panel when the fill container is fully compressed. At higher fill powers, fill container compression may be reduced by an amount 84 as the container fabric increases in material relative to the lower density of the fill material.

One skilled in the art would also understand that a higher quality down retains its loft and firmness, resulting in longer life under compression and expansion, and further that natural down provides less affinity or “stickiness” to other down clusters compared to synthetic down, and which has improved aesthetics and weight in comparison to synthetic down. Attraction of the fill material to the container fabric walls of compartments 60 improves insulating and aesthetic properties, and the long term consistency of the fill distribution. Preferably, for use in some embodiments of the present invention fill material 80 is natural goose down at approximately 800 in³/oz (460 cm³/g) fill power.

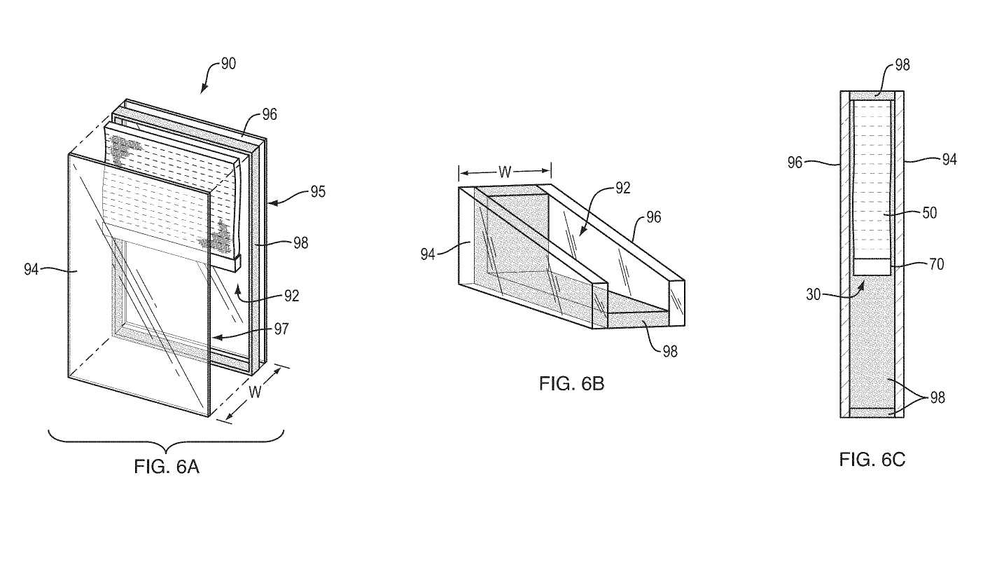

FIGS. 5A-5D show alternative patterns or structures for the compartments 60 of compressible fill container 50. Each of these structures offers advantages and disadvantages in complexity of the stitching and thus manufacturability and cost, compressibility, and the ability to maintain substantially uniform distribution of the fill material as the fill container is repeatedly compressed and expanded. One skilled in the art would understand how to manufacture the various fill container structures shown, and the tradeoffs in cost and manufacturability for each. For example, a traditional “Bavarian” quilt structure (not shown) with two pieces of fabric horizontally stitched without joining fabric pieces leads to light and dark patterns, but is the easiest to manufacture. FIG. 5A depicts a “box quilt” structure constructed of two fabrics and inside fabric joining pieces. Box quilt structures are relatively easy to produce but tend to distribute the fill material unevenly at the bottom of the structures. FIG. 5B depicts a “slant” structures, which is more difficult to assemble but improves on the box results in a more even distribution of fill in any cross section of the window shade by the diagonal inside joining fabric. FIG. 5C depicts a “trapezoidal” structure with some advantages of the slant structure with somewhat easier stitching.

Preferably, as shown in FIG. 5D, and further illustrated in FIGS. 5E, fill container 50 is formed of “V” structured compartments. “V” structures offer overlapping portions of adjacent compartments which provide long-term uniformity in insulating fill distribution and light filtering aesthetics. By way of illustration, vertical compression of fill container 50 causes cells 66c, 66d, and 66e to compress fill material within each cell. With respect to a cross section of the fill container perpendicular to the window shade, the portion of cell 66d above center line 67d overlaps with the portion of cell 66c below center line 67c. Similarly, the portion of cell 66d below center line 67d overlaps with the portion of cell 66e above center line 67e. As fill container 50 is expanded vertically, the “V” shaped compartments of fill container 50 expands and allows the fill material disposed therein to return to its uniform shape and fill. Attraction of the fill material to the walls of cells 66c-e distributes fill material along each cell wall, thus creating a more uniform effect in filtering the light passing through the window shade.

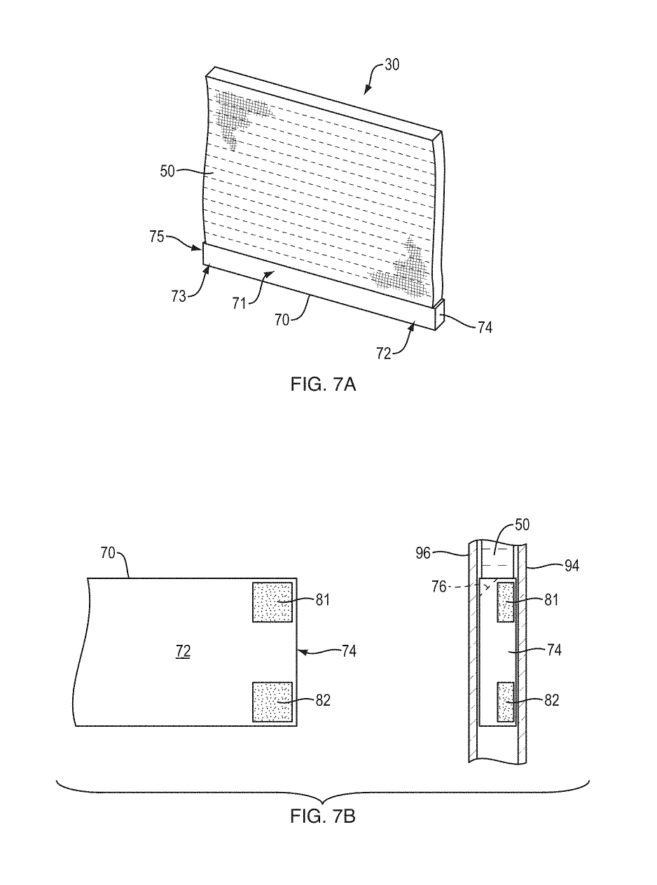

FIG. 6A depicts the insulating window panel 90 with insulating window shade 30 installed in the interior space 92 between glass window panes 94 and 96. Outer perimeter edges 95 and 97 of the windows panes are aligned in a parallel configuration and sealed to form the interior space 92 into which a gas, such as air, argon, or krypton may be filled. Alternatively, interior space 92 may be evacuated without loss of aesthetic qualities of the window shade and while retaining some of its insulating properties. FIG. 6B shows a corner cut-away view of a corner of window panel 90 formed according to the FIG. 6A and above. Seal 98 may include a desiccate for moisture control. Spacers (not shown) may be used to maintain separation of the window panes. Typical widths of glazed window panes w may be approximately % inches in the US. or may be up to 2 inches or more, or may 3 centimeters in the EU or up to 5 cm or more, according to the application and energy efficiency requirements or aesthetic design needs; however, any window panel spacing may be employed in applying the invention herein in various building designs. FIG. 6C is a side section view of window panel 90 showing window shade 30 in the interior space 92 formed by panes 94 and 96 and seal 98. Top end 52 of fill container 50 may be attached to a top portion of seal 98 by adhesive or by other means, thereby fixing a first end of the fill container in relation to divider 70. For additional insulating and aesthetic improvements, a low-E coating or other window glass treatments may be applied to panes 94 or 96.

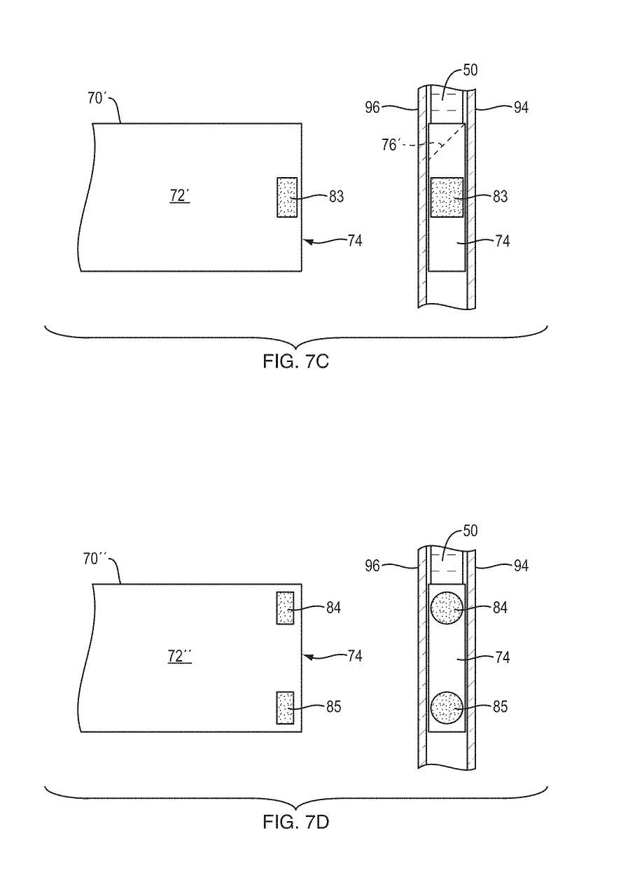

The structure and operation of divider 70 when used with insulating window shade 30 will now be described. As shown in FIG. 7A, window shade 30 may comprise a rigid divider 70 attached at a bottom end 54 of fill container 50. Divider 70 may be formed of low conductivity material, such as wood or plastic, in the shape of an elongated rectangle, elongated cylindrical tube, or other suitable shape for attachment to and moveable engagement with fill container 50 within window panel 90. Attachment to fill container 50 may include insertion into a horizontal compartment of the fill container. When installed within a sealed window panel 90, divider 70 may include holes or slits or other means to allow air or gas to equalize between divided portions of the window panel and to allow fill container 50 to inflate and deflate accordingly.

Divider 70 make take other forms, including there being no divider, the division of filled and unfilled interior space of window panel 90 defined by the extent of the fill container. In an alternative embodiment, fill container 70 may be compressed and expanded by other means, such as by pumping gas into a fill container made of a non-gas permeable “bag”, thus filling the space between the panes with insulating and aesthetically enhancing material. Fill container 30 may be deflated by pumping the gas from the bag back into the space between the panels and outside of the bag. A pump may be contained within the window panel, with the wires to control the pump passing through the sealed frame, or may reside external to the window panel or within a cavity the window frame.

Divider 70 may include magnets disposed on divider front face 71 at a first end portion 72 and/or second end portion 73. For example, FIG. 7B shows a front view and side view of divider 70 having two magnets 81 and 82 disposed on or integral to divider end portion 72. Magnets 81 and 82 as shown face perpendicular to window pane 94. Without loss of generality, any suitable number or position of magnets may be disposed on divider end portion 72. Similarly, one or more magnets may be disposed on divider side ends 74 and 75. For example, FIG. 7C shows divider end 72′ having magnet 83 disposed on or integral to divider side end 74. Magnet 83 may face a direction perpendicular to end 74 and parallel to window panes 94, 96. In another variation, FIG. 7D shows two magnets 84 and 85 disposed on or integral to divider side end 74 of divider end 72′ and facing in a direction parallel to window panes 94 and 96. Magnets 81-85 may be any suitable shape, such as rectangular, square, round or irregular, and may vary by size and type, polarity or strength of magnetism. Dividers 70 and 70′ may have a recessed portions 76,76′ to allow additional collapsing of the fill container 50 into the recess.

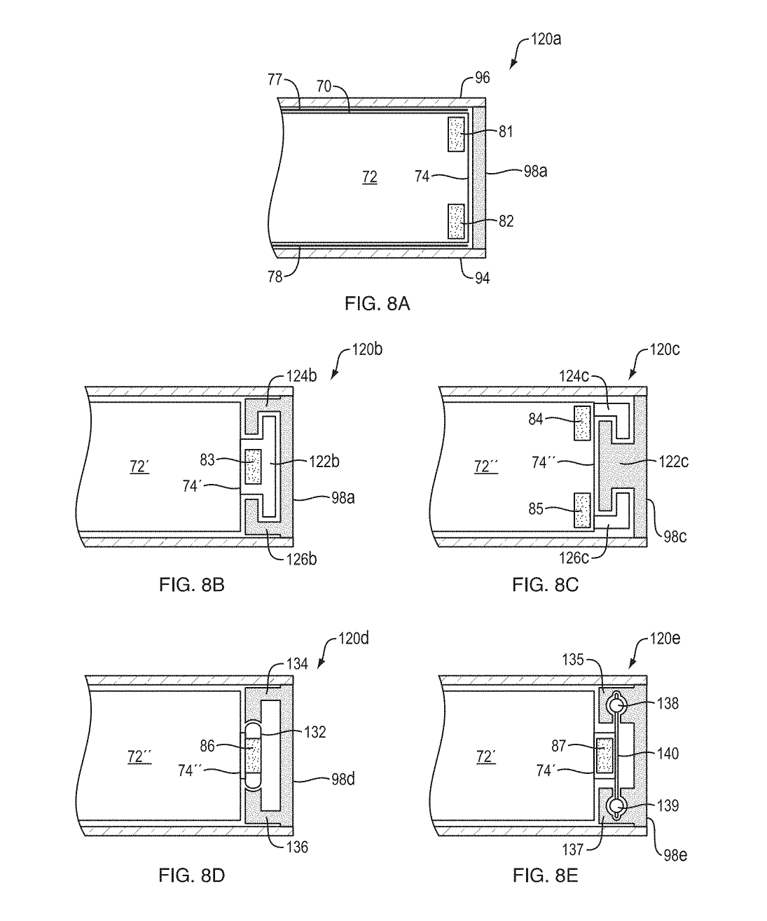

As previously depicted in FIG. 6C, divider 70 when disposed in window panel 90 may be in frictional contact with panes 94, 96 and/or seal 98 such that movement of the divider within the interior space 92 may be restricted. FIG. 8A shows a top down view of divider 70 at a side end 74 of a divider “floating” (i.e. with no guide assembly, as further described below) between window panes 94 and 96. To reduce friction between divider 70 and window panes 94 and 96, there may be disposed in gaps 77 and 78 a friction-reducing film or pad or wheels. A film or friction pad or wheels (not shown) may be disposed between divider end 74 and seal 98a to reduce friction as the divider moves within the window panel.

FIGS. 8B-8E depict alternative embodiments of divider guide assemblies for ensuring alignment of the divider within window panel as the divider moves vertically within the interior space of the window panel. As shown, a film or friction pad may be disposed at gaps between the divider and window panes 94 and 96, as above, or the use of divider guide assemblies may provide sufficient separation to avoid restriction of divider movement. For example, FIG. 8B shows divider guide assembly 120b having “T” shaped guide 122b disposed at divider side end 72′ of divider end 72′, the guide 122b being engaged with “T” track portions 124b, 126c, disposed along or integrally formed with seal 98b. Magnet 83 may be disposed on or integral to divider end 74′, according to the embodiments shown and described above, or may be disposed wholly or partially within the leg portion of “T” guide 122b as shown in FIG. 8B. FIG. 8C shows an alternative divider guide assembly 120c having “T” shaped guide 122c disposed along seal 98c and engaged with “T” track portions 124c, 126c disposed on divider side end 74″. Magnets 84 and 85 may be disposed on or integral to divider end 74″. For each of divider guide assemblies 120b and 120c, track portions 124b and 126b and guides 122b may be integrally formed with seals 98b and 98c, respectively, and may be formed of extruded aluminum or plastic material.

Alternatively, FIG. 8D divider guide assembly 120d may have roller bearing 132 disposed at divider side end 74″ engaged with roller bearing track portions 134 and 136. Magnet 86 may be disposed on or integral to divider end portion 72″ according to the embodiments shown and described above, or may be disposed wholly or partially within or integral to roller bearing 132 as shown. In yet another alternative, divider guide assembly 120e as shown in FIG. 8E may have ball bearings 138, 139 disposed in ball bearing track portions 135, 137 at divider side end 74e and engaged with roller bearing support 140. Preferably, roller bearing track portions 135, 137 and ball bearing track portions 135, 137 are integrally formed with seals 98d and 98e, respectively.

Magnet 87 may be disposed on or integral to divider end portion 72′ according to the embodiments shown and described above, or may be disposed wholly or partially within a portion of ball bear support 140 as shown.

Divider guide assemblies 120b-e of the various embodiments above may be provided at one side end 72 or 74 or preferably both side ends 72, 74 of divider 70. One skilled in the art would recognize variations in the material, structure, size, composition of divider guide assemblies, or the application of other guide assemblies in other manners than shown and described here, consistent with aspects of the present invention.

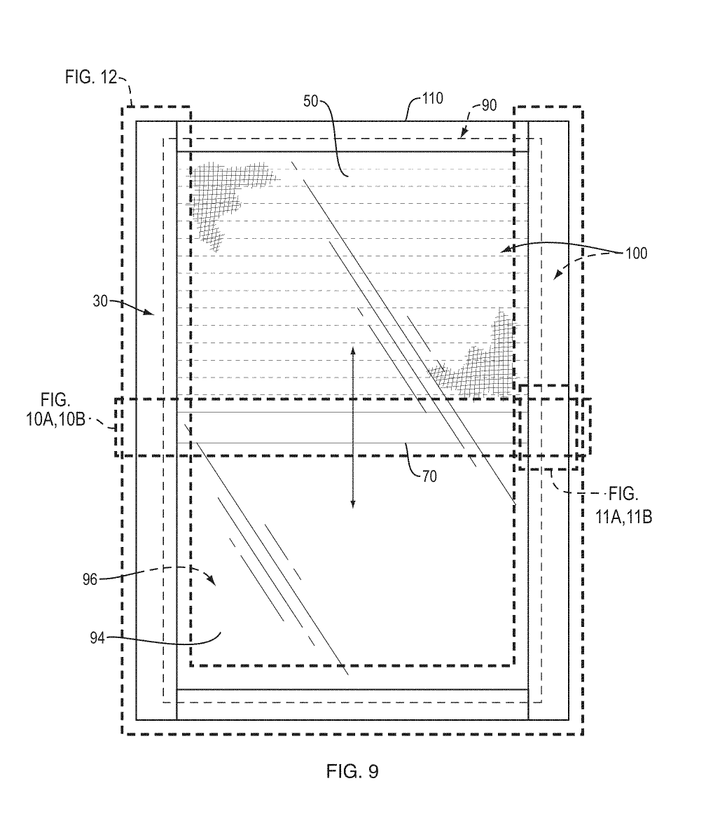

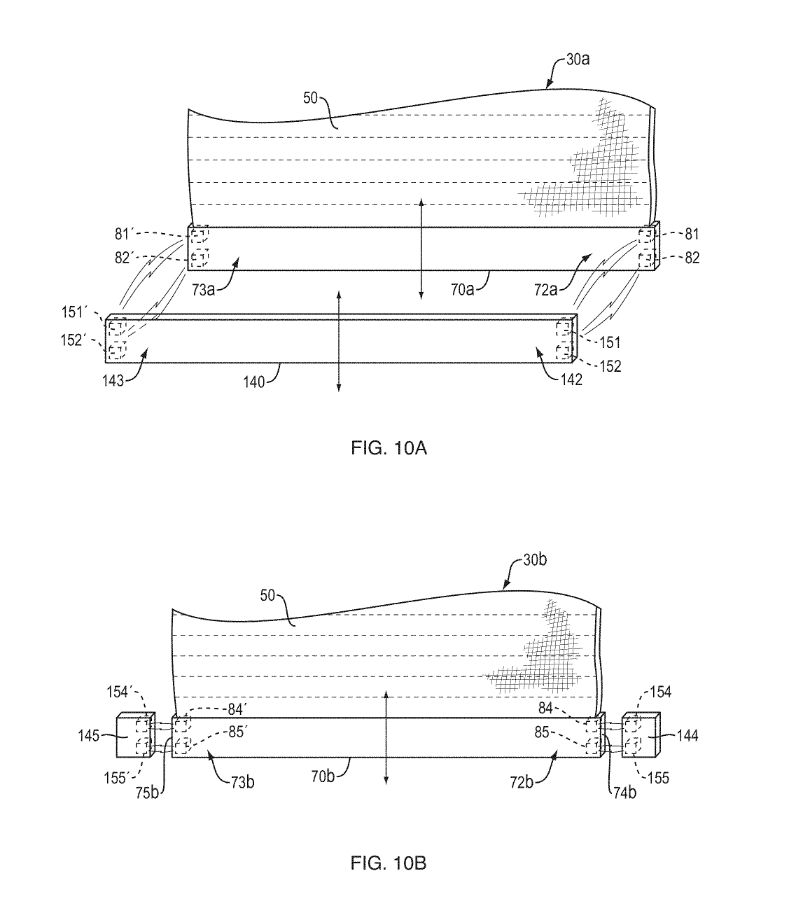

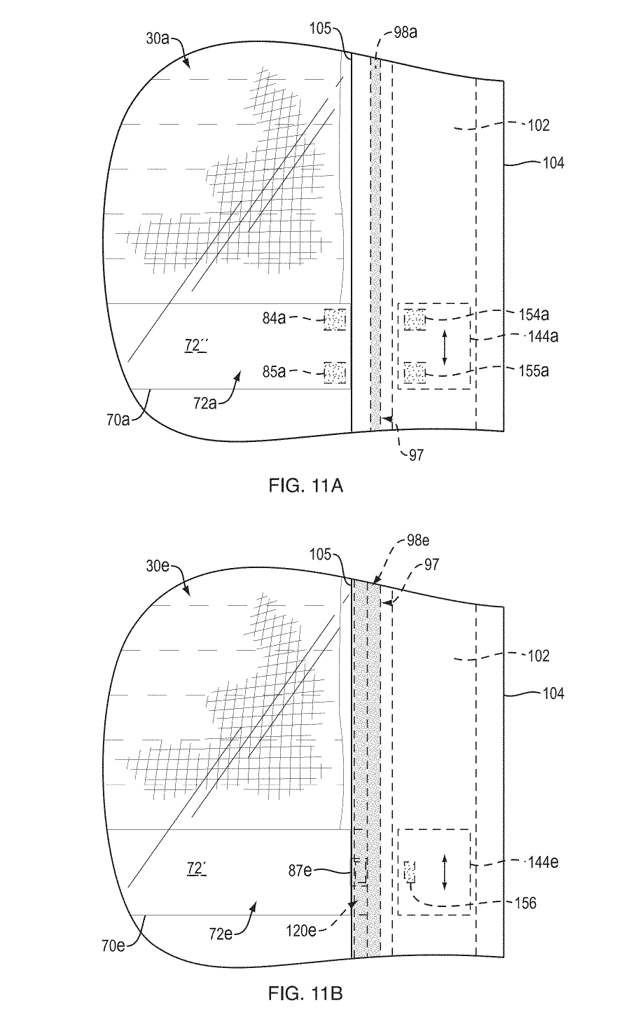

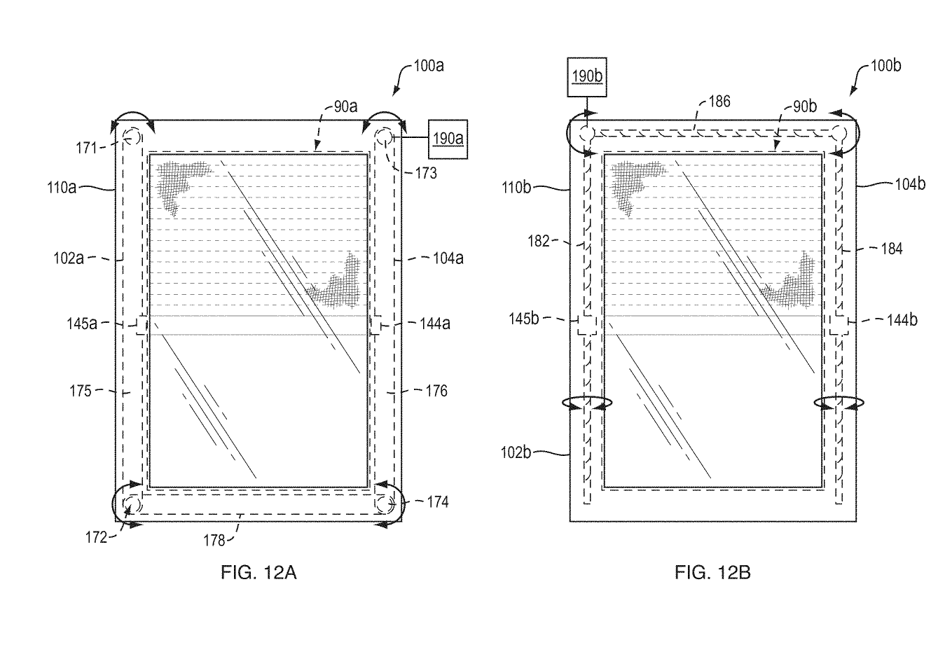

FIG. 9 provides an overview of the insulating window assembly 100 for installation in window frame 110, according to the present invention. Window frame 110 may be conventional or modern, pre-fabricated or custom-built. As previously discussed in view of FIGS. 3A-3C and 6A-6C above, insulating window assembly 100 may be comprised of insulating window panel 90 with insulating window shade 50 installed between glazed window panes 94, 96. Window shade 50 may include divider 70 having divider magnets and divider guide assemblies according to embodiments shown and described for FIGS. 7A-7D and 8A-8E. Window assembly 100 may further include a divider control to be further described below in reference to FIGS. 10A and 10B. Window assembly 100 may further include divider engagement members to be further described below in reference to FIGS. 11A and 11B. Window assembly 100 may further include divider coordination to be further described below in reference to FIGS. 12A and 12B.

Generally, according to embodiments of the invention, moving the dividers can be achieved in various ways, with manual systems, automated systems or combinations thereof. In one embodiment, a manual system is utilized which includes magnets attached to the dividers. These magnets are attracted to a corresponding set of magnets attached to a beam or handles on the exterior of window panel. On the exterior side of the window pane the magnets on the beam or handles mate to the magnets on the divider, such that when the beam or handles are moved, the divider moves with it. Both the beam or handles and the divider may make contact with the pane by means of either a low friction pad or film or low friction rollers.

Generally, the exterior beam or handles may be moved by a lead screw assembly or a conveyor assembly and the like, or by hand, or may be moved manually by a rope and pull system. Further, such divider movement can be automated in a number of ways. In an automated system, divider movement can be activated by sensors keyed to time of day and date, temperature, light availability and intensity, energy usage plans or requirements, proximity to spaces within and outside a building or structure, or other control parameters.

FIG. 10A illustrates the divider movement control according to one embodiment having window shade 30a with divider 70a having magnets 81, 82 disposed on divider ends 72a, 73a according to embodiments shown and described above. Divider control beam 140 residing exterior to window panel 90 (not shown) has magnets 151, 152 disposed on beam ends 142, 143 corresponding and engaging with, when in close proximity, to magnets 81, 82 disposed on divider end portions 72a and 73a. Alternatively, divider control beam 140 may be constructed of separated handles (not shown) each having magnets corresponding and engaging with divider end portions 72a and 73a. Preferably, when no divider guide assembly is used, e.g. according to FIG. 8A the “floating” divider, two magnets may be disposed on each end of divider 70a and beam 140 to prevent longitudinal rotation of the divider within the window panel. Alternatively, when divider guide assemblies according to FIGS. 8B-8E are used, a single magnet may be employed on each divider end portions 72a, 73a and beam ends 142, 143, with the divider guide assemblies preventing rotation of the divider within the window panel.

FIG. 10B depicts an embodiment of a divider control having window shade 30b including fill container 50 with divider 70b and magnets 84, 85 and 84′,85′ disposed on divider side ends 74b and 75b. Divider engagement member 144 residing exterior to window panel 90b has magnets 154, 155 disposed on or integral thereto and corresponding to magnets 84, 85 disposed on or integral to divider side end 74b. Similarly, divider engagement member 145 residing exterior to window panel 90b has magnets 154′, 155′ disposed on or integral thereto and corresponding to magnets 84, 85 disposed on or integral to divider side end 74b. Alternatively, single magnets may be employed in proximity to divider ends 74b, 75b and divider engagement members 144, 145, respectively. Further details of the structure and operation of divider engagement members follows.

FIG. 11A shows a cut-away view of an insulating window panel having insulating window shade 30a installed interior to the window panel. Divider 70a is shown with magnets 84a, 85a integral to divider end portion 72″ substantially as shown and described for FIG. 10B. Divider engagement member 144a has magnets 154a, 154b in magnetic communication with corresponding magnets 84a, 85a. When magnetically engaged, vertical movement of divider engagement member 144a enables movement of divider 70a, causing the compression of fill container 50, thereby changing the aesthetic and/or insulating properties of the insulating window shade. Divider engagement member 144a may reside in window frame cavity 102 formed by window frame side member 104. Window frame side member edge 105 may overlap and hide from view portions of the window panel including panel edge 97 and/or seal 98a.

Similarly, FIG. 11B shows a cut-away view of an insulating window panel having insulating window shade 30e. Divider 70e is shown with magnet 87e integral to divider end portion 72′, substantially as shown and described for FIG. 7C. By way of example, divider 70e may include divider guide assembly 120e substantially as shown and described for FIG. 8E. Divider engagement member 144e has magnet 156 corresponding to magnet 87. Vertical movement of divider engagement member 144e enables movement of divider 70e compressing fill container 50, thereby changing the aesthetic and/or insulating properties of the insulating window shade. Divider engagement member 144e may reside in window frame cavity 102 formed by window frame side member 104. Window frame side member edge 105 may overlap and hide from view portions of the window panel including panel edge 97 and/or seal 98e.

Generally, divider engagement members in the various embodiments as above may be moved vertically by a set of conveyors having two belts, one on each side of the window panel running perpendicular to the divider. The conveyors may run the length of the panel and be held in place by pulleys at the end of the panel, or may run only partially along the panel, on one or both sides of the window. The conveyors may be coordinated by pulleys and may be driven by one or more motors connected to one or more of the pulleys. Conveyors on each side of a window panel may be housed within the cavity of a window frame. Conveyors may be coordinated by a third conveyor connecting one pulley of each of the side conveyors, so that both conveyors are synchronized. A motor or manual operation may drive one or more pulleys causing the divider to move within the window panel.

For example, FIG. 12A shows insulating window assembly 100a installed in window frame 110a according to the above described embodiments and variations. Divider engagement members 144a and 145a may be attached to belts, chains or cables by pulley or gear 171, 172, 173, and 174 forming conveyors 175 and 176. Conveyors may be enclosed in cavity 102a of window frame 110a and may rotate in the plane of the window panel as shown, or in a plane perpendicular to the window panel. Conveyors 174, 176 thus move divider engagement members 144a, 145a perpendicularly to divider, and may synchronized by a third conveyor 178 to enable coordinate movement of both ends of the divider.

Alternatively, divider engagement members may be moved by lead screws on each side of the window panel running perpendicular to the divider on one or both sides of the window panel. The lead screws may run the length of the window panel and be held in place by brackets attached to the head or sill of the window frame, or may run only partially along the window panel. Lead screws on each side of the window panel may be coordinated by a third lead screw or by a conveyor as above so that both side lead screws are synchronized. A motor or manual operation may drive one or more lead screws causing the divider engagement member to move within the window panel.

For example, FIG. 12B shows insulating window assembly 100b installed in window frame 110b according to the above described embodiments and variations. Divider engagement members 144b and 145b may contain nuts at either end or integral thereto that run along a pair of lead screws 182 and 184 parallel to each side of window panel 90b. Lead screws may be enclosed in cavity 102b and 104b of window frame 110a and may rotate clockwise or counterclockwise in a plane perpendicular to the window frame. Lead screws 182, 184 thus move divider engagement members 144b, 145b perpendicularly to divider 70a. Lead screws 182, 184 may be synchronized by a third lead screw 186 to enable coordinate movement of both ends of the divider.

In each of the above divider coordinated control embodiments, turning of the conveyor or lead screw may be motorized. Motors 190a and 190b as depicted in FIGS. 12A and 12B may be controlled by a control board. The board may be powered by wires which exit the sealed frame of the panel. The board may be connected to sensors (Hall effect, pressure, switch, etc.) at either end of the window panel. When the divider engages a sensor, the sensor signals the board that the divider has reached the sensor's location, and the board cuts power to the motor. The board powers the motor to move the divider from a first position to a second position The motor may be controlled by a device such as a thermostat, timer, manual switch, smart phone or some combination, so that the divider will move at a designated temperature, time, or at the desire of the operator.

Alternatively, lead screws may be installed within the window panel and connected directly to the divider. In this alternative, no divider engagement member is needed and no magnets are required in the divider. The divider may contain nuts at either end or integral thereto that run along a pair of lead screws parallel to each side of the window panel. One or more lead screws within the panel may be turned by one or more motors residing external to the window panel and having magnets to engage the lead screw inside the panel. As the lead screws turn, the divider moves inside the pane.

As another alternative, a rack and pinion system has one or more pinion(s) that runs along one or more racks running perpendicular to the divider. As the pinions rotate, it drives the divider to move along the rack. In a piston system, the divider is attached to pistons (pneumatic or hydraulic) which move the divider within the panel. Using pressure differential with an adequate seal around its perimeter, the divider is moved by changing the pressure on either side. A small pump could move gas from below the divider to above it, moving the divider down. The pump then moves gas from above the divider to below it, moving the divider back up.

In variety of configurations in some window frames, there could be three or more panes of window glass forming two or more interior spaces each with an insulating window shade providing for four or more possible, each with a unique set of insulating and aesthetic properties. Window panes may be of various shapes and orientations. The insulating window panel may be installed in a variety of window frames known in the art, such as skylights, or may be installed as panels without frame, such as in a translucent glass wall application. Using motorized controls as above, multiple windows may be linked so as to move in unison from one or multiple devices.

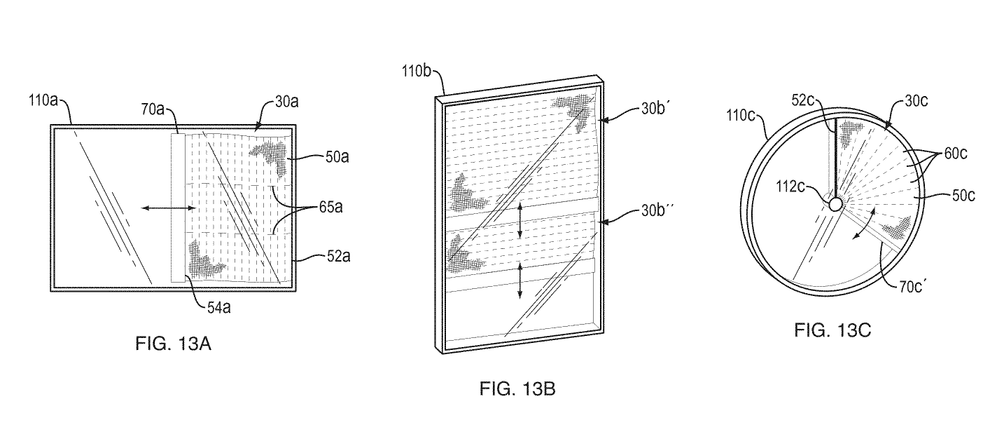

For example, as shown in FIG. 13A, insulating window shade 30a is rotated ninety (90) degrees in casement window frame 110a. Compression of fill container 50a thus occurs in a lateral direction from a first fill container end 54a to a second fill container end 52a. Here, vertical stitching 65a may form two or more compartments to hold fill material in a substantially uniform distribution within the fill container 50a. As shown in FIG. 13B, two or more insulating window panels 30b′ and 30b″ may be installed in one or more panels of multi-panel window 110b. One skilled in the art would recognize the structure and operation of each window panel and window assembly, separately controlled or under coordinated control, would follow according to the above described embodiments. In a circular window frame 110c as shown in FIG. 13C, insulating window shade 30c may be constructed of radial compartments 60c and radial divider 70c fixed at a center frame member 112c. In this embodiment, radial divider 70c may compress fill container 30c in the clockwise or counterclockwise direction of fixed fill container end 52c or a second divider (not shown) fixed or moveable and attached to fill container end 52c.

While the foregoing description of the invention enables one of ordinary skill to make and use what is considered presently to be the best mode thereof, those of ordinary skill will understand and appreciate the existence of variations, combinations, and equivalents of the specific embodiments and examples herein. The above-described embodiments of the present invention are intended to be examples only. Alterations, modifications and variations may be effected to the particular embodiments by those of skill in the art without departing from the scope of the invention, which is defined solely by the claims appended hereto.

The invention is therefore not limited by the above described embodiments and examples, embodiments, and applications within the scope and spirit of the invention claimed as follows.

1. An insulating window shade for installation within the interior space between sealed window panes, the window shade comprising:
a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position;
a fill material disposed substantially uniformly within the compressible fill container, wherein the fill material is capable of being repeatedly compressed and expanded as the compressible fill container is moved between the expanded position and the compressed position;
wherein, when in the compressed position, the length of the compressible fill container is approximately 25% or less than the length of the compressible fill container in the expanded position;
wherein the compressible fill container comprises a quilted fabric forming compartments for holding and maintaining the substantially uniform distribution of the fill material; and
wherein the compressible fill container fabric is a fabric selected from synthetic or natural cotton, nylon mesh, or other gas-permeable material.

2. The insulating window shade of claim 1, further comprising a divider member attached to the second end of the compressible fill container, the divider member comprising one or more magnets, which when magnetically engaged with an external divider control enables movement of the second end of the compressible fill container relative to the first end of the compressible fill container, thereby changing the aesthetic and/or insulating properties of the insulating window shade.

3. The window shade of claims 1, wherein the fill material is transparent or translucent.

4. The window shade of claims 1, wherein the fill material is selected from natural or synthetic down, wool, cotton, fiberglass, paper, or foam.

5. The insulating window shade of claim 4, wherein the fill material is down with a fill power between approximately 400 in³/oz (175 cm³/g) to 800 in³/oz (520 cm³/g).

6. (canceled)

7. The window shade of claim 1, wherein the compartments are formed as traditional baffles, box baffles, slant baffles, “V” baffles, vertical baffles, or trapezoidal baffles.

8. The window shade of claim 1, wherein the compressible fill container fabric is transparent or translucent.

9. (canceled)

10. An insulating window panel for installation in window frame, the window panel comprising:
a first window pane having a first outer edge and a second window pane having a second outer edge, wherein the first outer edge of the first window pane and the second outer edge of the second window pane are aligned and in a spaced relationship to one another, and wherein the first window pane and the second window pane are joined along their respective outer edges to form a sealed interior space; and
an internal insulating window shade disposed within the interior space formed between the first and second window panes, the interior insulating window shade comprising:
a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position;
a fill material disposed substantially uniformly within the compressible fill container, wherein the fill material is capable of being repeatedly compressed and expanded as the compressible fill container is moved between the expanded position and the compressed position;
wherein, when in the compressed position, the length of the compressible fill container is approximately 25% or less than the length of the compressible fill container in the expanded position; and
a divider member attached to the second end of the compressible fill container, the divider member comprising one or more magnets, which when magnetically engaged with an external divider control enables movement of the second end of the compressible fill container relative to the first end of the compressible fill container, thereby changing the aesthetic and/or insulating properties of the insulating window panel;
wherein the window panel further comprises divider guide assembly disposed on at least one end of the divider member for engaging corresponding guide assembly disposed along an interior edge of the interior space formed by the joining of the first or second window pane.

11. The window panel of claim 10, wherein the interior space between the first and second window pane is substantially uniformly filled with a gas selected from air, argon or krypton.

12. The window panel of claim 10, wherein at least one of the first and second window pane includes a low-E coating on a surface in the interior space.

13. The window panel of claim 10, wherein the insulating window shade is disposed vertically or horizontally within the interior space of the window panel formed by rectangular first and second window panes.

14. The window panel of claim 10, wherein the insulating window shade is disposed within the interior space of the window panel formed by substantially round first and second window panes.

15. The window panel of claim 10, wherein the divider member comprises one or more magnets integrally formed at a first end and at a second end of the divider member.

16. The window panel of claim 15, wherein the one or more magnets at the first and second ends of the divider member are disposed to face an interior surface of the first and second window panes.

17. The window panel of claim 15, wherein the one or more magnets at the first and second ends of the divider member are disposed to face an interior edge of the interior space formed by the joining of the first or second window panes.

18. The window panel of claim 10, further comprising is a low friction device or material interposed between the divider member and an interior surface of the first or second window pane allowing the divider member to move freely within the interior space of the window panel.

19. (canceled)

20. The window panel of claim 10 wherein the divider guide assembly comprises a “T” track or inverted “T” track disposed on at least one end of the divider member, and wherein the window panel further comprises an inverted “T” track or “T” track disposed along a corresponding interior edge of the interior space of the window panel.

21. The window panel of claim 10 wherein the divider guide assembly comprises a roller bearing disposed on at least one end of the divider member in communication with roller bearing track means disposed along a corresponding interior edge of the interior space of the window panel.

22. The window panel of claim 10 wherein the divider guide assembly comprises ball bearing means disposed on at least one end of the divider member in communication with ball bearing track means disposed along a corresponding interior edge of the interior space of the window panel.

23. A window assembly for installation in a window frame, comprising:
an external divider control assembly comprising one or more divider engagement members having one or more magnets integrally formed thereto and disposed external to the insulating window panel;
an insulating window panel, comprising:
a first window pane having a first outer edge and a second window pane having a second outer edge, wherein the first outer edge of the first window pane and the second outer edge of the second window pane are aligned and in a spaced relationship to one another, and wherein the first window pane and the second window pane are joined along their respective outer edges to form a sealed interior space; and
an insulating window shade disposed within the interior space formed between the first and second window panes, the interior insulating window shade comprising:
a compressible fill container having a first end and a second end and a length defined as the distance between the first end and the second end, wherein the first end of the compressible fill container is configured to be affixed to a first location within the interior space and the second end of the compressible fill container is configured to be moveable relative to the first end between an expanded position and a compressed position;
a fill material disposed substantially uniformly within the compressible fill container, wherein the fill material is capable of being repeatedly compressed and expanded as the compressible fill container is moved between the expanded position and the compressed position;
wherein, when in the compressed position, the length of the compressible fill container is approximately 25% or less than the length of the compressible fill container in the expanded position; and
a divider member attached to the second end of the compressible fill container, the divider member comprising one or more magnets, which when magnetically engaged with an external divider control enables movement of the second end of the compressible fill container relative to the first end of the compressible fill container;
wherein the external divider control provides for translation of the one or more divider engagement members enabling movement of the divider member, thereby compressing the compressible file container and changing the aesthetic and/or insulating properties of the insulating window panel;
wherein the external divider control assembly comprises two divider engagement members, each having one or more magnets integrally formed and which magnetically couple to magnets integrally formed on a corresponding first and second end of the divider member; and
wherein the external divider control further comprises a conveyor belt assembly for coordinated movement of the divider engagement members.

24. (canceled)

25. The window assembly of claim 23 wherein the external divider control further comprises a lead screw assembly for coordinated movement of the divider engagement members.

26. The window assembly of claim 25, wherein the lead screw assembly is installed within the window panel and controlled by one or motors residing outside the window panel.

27. (canceled)
